(19) United States
(12) Patent Application Publication
(10) Pub. No.: US 2008/0249337 A1
(43) Pub. Date: Oct. 9, 2008

(54) Oxidation of Methane to Methanol using a Catalyst Containing a Transition Metal

(76) Inventors: Wensheng Chen, Hoffman Estates, IL (US); Timothy A. Brandvold, Arlington Heights, IL (US); Joseph A. Kocal, Glenview, IL (US); Maureen L. Bricker, Buffalo Grove, IL (US); Mary J. Lanuza, Wheeling, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/697,776

(22) Filed: Apr. 9, 2007

(51) Int. Cl. C07B 41/02

(52) U.S. Cl. 568/910.5

(57) ABSTRACT

A process for the oxidation of methane to methanol has been developed. The process involves contacting a gas stream, comprising methane, a solvent and an oxidizing agent with a catalyst at oxidation conditions to produce a methyl ester. Finally, the methyl ester is hydrolyzed to yield a methanol product stream. The catalyst comprises a transition metal component such as manganese oxide and an inorganic oxide such as silica. The transition metal component can be dispersed onto the inorganic oxide.

### FIELD OF THE INVENTION

This invention relates to a process for converting methane to methanol using a catalyst comprising a transition metal component such as manganese oxide and an inorganic oxide component. Generally the process involves contacting a gas stream, comprising methane, a solvent, and an oxidizing agent with the catalyst at oxidation conditions to produce a methyl ester. Finally, the methyl ester is hydrolyzed to yield a methanol product stream.

### BACKGROUND OF THE INVENTION

Today, both chemical and energy industries rely on petroleum as the principal source of carbon and energy. Methane is underutilized as a chemical feedstock, despite being the primary constituent of natural gas, an abundant carbon resource. Factors limiting its use include the remote locations of known reserves, its relatively high transportation costs and its thermodynamic and kinetic stability. Methane's main industrial use is in the production of synthesis gas or syngas via steam reforming at high temperatures and pressures. Syngas in turn can be converted to methanol also at elevated temperatures and pressures. The production of methanol is important because methanol can be used to produce important chemicals such as olefins, formaldehyde, acetic acetate, acetate esters and polymer intermediates. The above two step process for the production of methanol is expensive and energy intensive with corresponding environmental impacts.

Selective oxidation of methane has been studied for over 30 years by individual, academic and government researchers with no commercial success. For example, Sen et al. in New J. Chem, 1989, 13, 755-760 disclose the use of Pd (O₂C Me)₂ in trifluoroacetic acid for the oxidation of methane to CF₃CO₂Me. The reaction is carried out for 4 days at a pressure of 5516-6895 kPa (800-1000 psi). E. D. Park et al. in Catalysis Communications, Vol. 2 (2001), 187-190, disclose a Pd/C plus Cu (CH₃COO)₂ catalyst system for the selective oxidation of methane using H₂/O₂ to produce H₂O₂ in situ. L. C. Kao et al. in J.Am.Chem.Soc., 113 (1991), 700-701 disclose the use of palladium compounds such as Pd (O₂CC₂H₅)₂ to oxidize methane to methanol in the presence of H₂O₂ and using trifluoroacetic acid as the solvent. U.S. Pat. No. 5,585,515 discloses the use of catalysts such as Cu(I) ions in trifluoroacetic acid to oxidize methane to methanol. WO 2004069784 A1 discloses a process for the oxidation of methane to methanol using transition metals such as cobalt or manganese in trifluoroacetic acid. Finally, M. N. Vargaftik et al in J. Chem. Soc., Chem. Commun. 1990(15) pp. 1049-1050 disclose results for a number of metal perfluoro acetate compounds. The metals which were found to be active were Pd, Mn, Co and Pb. Copper was found to have virtually no activity.

Applicants have developed a process which uses a catalyst comprising a transition metal component such as manganese oxide and an inorganic oxide component. Methane, a solvent such as trifluoroacetic acid and an oxidizing agent such as air are contacted with the catalyst at oxidation conditions to provide a methyl ester. The methyl ester, e.g. methyl trifluoroacetate, is subsequently hydrolyzed to give a methanol stream.

### SUMMARY OF THE INVENTION

As stated, this invention relates to a process for converting methane to methanol comprising contacting a gas stream comprising methane with a catalyst comprising a transition metal component selected from the group consisting of manganese, cobalt, silver, iron and mixtures thereof and an inorganic oxide component, in the presence of an oxidizing agent selected from the group consisting of air and oxygen and a solvent at oxidation conditions to provide a methyl ester compound and hydrolyzing the methyl ester compound at hydrolysis conditions to provide a methanol product stream. One example of a transition metal component is manganese oxide, while an example of a solvent is trifluoroacetic acid.

Additional objects, embodiments and details of this invention can be obtained from the following detailed description of the invention.

### DETAILED DESCRIPTION OF THE INVENTION

The present invention relates to a process for the oxidation of methane to methanol. One necessary component of the invention is a catalyst comprising a transition metal component and an inorganic oxide component. The transition metal is selected from the group consisting of manganese, silver, cobalt, iron and mixtures thereof. The transition metal component used can be any form which is active in catalyzing the selective oxidation of methane to methanol. Specific examples of the transition metal compounds which can be used include without limitation, metal oxides, metal salts, organometallic compounds, etc. The transition metal compounds can be added to the solvent (described below) or be combined with the inorganic oxide component. Examples of transition metal compounds include without limitation Mn₂O₃, Mn₃O₄ MnO₂, KMnO₄, K₂Mn₄P₃O₁₆, MnPO₄.H₂O, Na₂Mn₂P₂O₉.H₂O, KMn₈O₁₆, Mn(II)trifluoroacetate, Mn(II) acetate, Mn(III)acetate, CO₂O₃, Co(II) Acetate, AgO, Ag(I)trifluoroacetate, Fe₂O₃, (FeMn)PO₄, etc. The inorganic oxide component which can be used include but are not limited to aluminas, silica, silica-alumina, molecular sieves, ceria, zirconia, titania, magnesium oxide, lanthanum oxide, aluminum phosphate, etc. It should be pointed out that silica-alumina is not a physical mixture of silica and alumina but means an acidic and amorphous material that has been cogelled or coprecipitated. This composition is well known in the art, see e.g. U.S. Pat. No. 3,909,450; U.S. Pat. No. 3,274,124 and U.S. Pat. No. 4,988,659 all of which are incorporated by reference in their entirety. Molecular sieves include zeolites and non-zeolitic molecular sieves (NZMS). Examples of zeolites include, but are not limited to, zeolite Y, zeolite X, zeolite L, zeolite beta, ferrierite, MFI, mordenite and erionite. Non-zeolitic molecular sieves (NZMS) are those molecular sieves which contain elements other than aluminum and silicon and include silicoaluminophosphates (SAPOs) described in U.S. Pat. No. 4,440,871, ELAPOs described in U.S. Pat. No. 4,793,984, MeAPOs described in U.S. Pat. No. 4,567,029 all of which are incorporated by reference. Aluminas include without restriction gamma alumina, delta alumina, eta alumina and theta alumina.

The transition metal component and inorganic oxide component can be present as separate components or the transition metal component can be combined with the inorganic oxide. If the transition metal compound is soluble it can be deposited onto the inorganic oxide by methods well known in the art which include without limitation impregnation, precipitation, etc. A preferred method is impregnation.

Impregnation is carried out by preparing a solution of a transition metal compound and then contacting the inorganic oxide with the solution for a time sufficient to absorb the transition metal compound onto the inorganic oxide. The transition metal compounds which can be used to prepare the solution include without limitation the oxide, hydroxide, nitrate, acetate, halides, e.g. chloride, oxalate, acetylacetonate, specific examples of which are enumerated above. In addition transition metal complexes which contain neutral or charged coordinating ligands can also be used. Water is the solvent which is usually used to prepare the solution although organic solvents such as ethanol or acetone can be used. Once the compound is absorbed onto the inorganic oxide, it is dried and then calcined at a temperature of about 100° C. to about 800° C. for a time of about 1 hr. to about 48 hrs. Depending on post synthesis treatment conditions the metal may be on the inorganic oxide component as a metal cation, metal oxide, reduced metal, or a mixture thereof. Regardless of the form of the transition metal on the inorganic oxide component, the transition metal is present in an amount from about 0.1 wt. % to about 10 wt. % of the catalyst as the metal.

Whether the inorganic oxide component has the transition metal component dispersed on it or not, it can be used in the form of a powder or a shaped article. Examples of shaped articles include without limitation spheres, pills, pellets, extrudates, irregularly shaped particles, etc. Means for preparing these shaped articles are well known in the art. If the transition metal compound is deposited onto the inorganic oxide by impregnation, deposition of the transition metal compound can be done either before or after the powder is formed into a shaped article although not necessarily with equivalent results. Metal impregnation before forming is preferred. In the case of a transition metal oxide, it can be deposited on an inorganic oxide by commingling it with the inorganic oxide and then forming it into a shaped article by means such as extrusion, marumerizing, pelletizing, etc.

Having obtained the catalyst, it is used to catalyze the oxidation of methane to methanol as follows. The process can be carried out in a batch process or a continuous process. In a batch process, the catalyst is placed into a reactor, to which is added a solvent followed by the addition of methane. Non limiting examples of solvents are trifluoroacetic acid, trifluoroacetic anhydride, pentafluoropropionic acid, acetic acid, super critical carbon dioxide, sulfuric acid, sulfur trioxide, trifluoromethanesulfonic acid, methanesulfonic acid and mixtures thereof with trifluoroacetic acid being preferred. To the mixture of catalyst and solvent is added methane in a concentration to produce a pressure of about 103 kPa (15 psig) to about 6895 kPa (1000 psig) and preferably from about 4137 kPa (600 psig) to about 6895 kPa (1000 psi). In addition to methane, catalyst and solvent, an oxidizing agent is necessary to carry out the reaction. Air is the usual oxidizing agent, although pure oxygen can be used, as well as synthetic blends containing oxygen and an inert gas such as nitrogen, argon, helium, etc. Atmospheric air contains approximately 21% oxygen as a mixture with 78% nitrogen, and less than 1% carbon dioxide, water, and other trace gases. If air or other gaseous oxidizing agent is used, then the oxidizing agent is typically added to the reaction mixture directly from a compressed gas cylinder or tank or via atmospheric source with a mechanical compressor. The concentration of oxidizing agent can vary from about 1 mole % to about 100 mole %. The pressurized reaction vessel is now heated at a temperature of about 25° C. to about 250° C. and preferably from about 60° C. to about 100° C. The vessel is held at this temperature for a time of about 1 minute to about 24 hours in order to contact the methane with the oxidizing agent, catalyst and solvent and provide a mixture comprising a methyl ester formed from the methane and an adduct from the solvent.

The methyl ester formed, such as methyl trifluoroacetate, can be separated from the reaction mixture by any suitable methods but distillation is preferred. The methyl ester, e.g. methyl trifluoroacetate (MTFA) is now hydrolyzed to produce free methanol and regenerate the solvent. Using MTFA as an example, although it is understood that the process is not limited to MFTA, the MFTA is introduced into a hydrolysis reactor along with water. The amount of water introduced is at least the stoichiometric amount required for complete hydrolysis although it is preferred to use an excess amount of water. A catalyst and a co-solvent may also be used. A variety of acidic and basic substances are known to promote ester hydrolysis. Suitable acids include but are not limited to hydrochloric acid, sulfuric acid, trifluoroacetic acid, toluene sulfonic acid, acidic alumina, silica-alumina, sulfated zirconia, and acidic ion exchange resins, and suitable basic materials include but are not limited to sodium hydroxide, lithium hydroxide, potassium hydroxide, and solid bases such as hydrotalcite. Acid hydrolysis is preferred to allow easy recovery of the trifluoroacetic acid solvent/product. When hydrolysis is complete the methanol product can be separated from the reaction mixture by a variety of methods known in the art including distillation, adsorption, extraction and diffusion through a membrane. Separation of trifluoroacetic acid is achieved by analogous methods. The recovered trifluoroacetic acid is then recycled to the oxidation reactor.

In addition to carrying out the process in a batch mode as described above, the process can also be conducted in a continuous mode as follows. The catalyst is placed in a fixed bed high pressure reactor and the methane, oxidizing agent and solvent flowed through the bed at the temperatures and pressures set forth above. Methane, oxidizing agent and solvent may be added independently to the reactor or mixed prior to introduction to the reactor. The solvent/methane/oxidizing agent mixture is flowed through the catalyst bed at a liquid hourly space velocity (LHSV) of about 0.1 hr⁻¹ to about 100 hr⁻¹ Gas and liquid are removed from the reactor continuously at a rate to maintain the liquid level and total pressure in the reactor. The removed gas/liquid stream is transferred to a vessel where the gas and liquid are separated and one or both streams may be subjected to further separation or returned to the high pressure reactor.

The following examples are presented in illustration of this invention and are not intended as undue limitations on the generally broad scope of the invention as set out in the appended claims.

### EXAMPLE 1

To an 80 cc Parr™ reactor were added 10 ml of trifluoroacetic acid (TFA) and 300 mg of silica obtained from Grace Davison and identified as SI 1254. The reactor was assembled and pressurized first with methane to 600 psig, then with 1000 psig of 8% oxygen in nitrogen. The reactor was heated at 180° C. for 3 hours. The liquid sample was analyzed by GCMS and the gas sample analyzed by GC equipped with FID, TCD and MS detectors. The estimated methane based yield was calculated based on methanol product (isolated as methyl trifluoroacetate) divided by methane introduced into the system. Methanol product was calculated based on GCMS analysis, and the amount of methane introduced into the system was based on the weight difference before and after the introduction of methane gas and ideal gas law occasionally. There was 0% methanol product formed in this reaction.

### EXAMPLE 2

To an 80 cc Parr™ reactor were added 10 ml of trifluoroacetic acid and 300 mg of a silica obtained from Grace Davison and identified as Grace 59. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 0% methanol product formed in this reaction.

### EXAMPLE 3

To an 80 cc Parr reactor were added 10 ml of trifluoroacetic acid and 22 mg of Mn₂O₃. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 0.39% methanol product formed in this reaction.

### EXAMPLE 4

To an 80 cc Parr reactor were added 10 ml of trifluoroacetic acid and 300 mg of 5% Mn impregnated on deactivated SI1254. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 4.08% methanol product formed in this reaction.

### EXAMPLE 5

To an 80 cc Parr reactor were added 10 ml of trifluoroacetic acid and 300 mg of 5% Mn impregnated on Grace 59. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 3.48% methanol product formed in this reaction.

### EXAMPLE 6

To an 80 cc Parr reactor were added 10 ml of trifluoroacetic acid and 22 mg of Mn₂O₃ and 285 mg of SI1254. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 2.95% methanol product formed in this reaction.

### EXAMPLE 7

To an 80 cc Parr reactor were added 10 ml of trifluoroacetic acid and 22 mg of Mn₂O₃ and 285 mg of Grace 59. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 2.37% methanol product formed in this reaction.

### EXAMPLE 8

To an 80 cc Parr reactor were added 10 ml of trifluoroacetic acid and 138 mg of (FeMn)PO₄. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 3.53% methanol product formed in this reaction.

### EXAMPLE 9

To an 80 cc Parr reactor were added 10 ml of trifluoroacetic acid and 84 mg of AgTFA. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 1.63% methanol product formed in this reaction.

### EXAMPLE 10

To an 80 cc Parr reactor were added 10 ml of trifluoroacetic acid and 84 mg of AgTFA and 285 mg of alumina. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 2.23% methanol product formed in this reaction.

### EXAMPLE 11

To an 80 cc Parr reactor were added 10 ml of trifluoroacetic acid and 84 mg of AgTFA and 285 mg of SI1254. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 4.44% methanol product formed in this reaction.

### EXAMPLE 12

To an 80 cc Parr reactor were added 10 ml of trifluoroacetic acid and 84 mg of AgTFA and 285 mg of Grace 59. The reactor was assembled and pressurized first with methane to 600 psig, then with 1000 psig of 8% oxygen in nitrogen. The reactor was heated at 180° C. for 3 hours. The liquid and gas samples were analyzed per example 1 and the yield and selectivity calculated per example 1. There was 4.15% methanol product formed in this reaction.

### EXAMPLE 13

To a 300 cc Parr reactor equipped with gas entrainment impeller were added 150 ml of trifluoroacetic acid. The reactor was assembled and pressurized first with methane to 100 psig, then with 8% oxygen in nitrogen to 600 psig. The reactor was heated at 180° C. for 3 hours. The liquid and gas samples were analyzed per example 1 and the yield and selectivity calculated per example 1. There was 0% methanol product formed in this reaction.

### EXAMPLE 14

To a 300 cc Parr reactor equipped with gas entrainment impeller were added 150 ml of trifluoroacetic acid and 150 mg of Mn₂O₃. The reactor was assembled and pressurized first with methane to 100 psig, then with 8% oxygen in nitrogen to 600 psig. The reactor was heated at 180° C. for 3 hours. The liquid and gas samples were analyzed per example 1 and the yield and selectivity calculated per example 1. There was 21.7% methanol product formed in this reaction. The calculated catalyst TON was 7.8.

### EXAMPLE 15

To a 300 cc Parr reactor equipped with gas entrainment impeller were added 150 ml of trifluoroacetic acid and 600 mg of 5% Mn/S11254. The reactor was assembled and pressurized first with methane to 100 psig, then with 8% oxygen in nitrogen to 600 psig. The reactor was heated at 180° C. for 3 hours. The liquid and gas samples were analyzed per example 1 and the yield and selectivity calculated per example 1. There was 27.1% methanol product formed in this reaction. The calculated catalyst TON was 53.

1. A process for converting methane to methanol comprising contacting a gas stream comprising methane with a catalyst comprising a transition metal component selected from the group consisting of manganese, cobalt, silver, iron and mixtures thereof and an inorganic oxide component, in the presence of an oxidizing agent selected from the group consisting of air and oxygen and a solvent at oxidation conditions to provide a methyl ester compound and hydrolyzing the methyl ester compound at hydrolysis conditions to provide a methanol product stream.

2. The process of claim 1 where the oxidation conditions comprise a temperature of about 80° C. to about 200° C., a pressure of about 103 kPa(15 psia) to about 6867 kPa (1000 psia), a contact time of about 1 minute to about 24 hrs and an oxidizing agent concentration from about 1 mol % to about 100 mol %.

3. The process of claim 1 where the hydrolysis conditions include a temperature of about 20° C. to about 200° C. and a pressure of about 103 kPa (15 psi) to about 1030 kPa (150 psi) and at least a stoichiometric amount of water.

4. The process of claim 1 further comprising carrying out the hydrolysis in the presence of a catalyst selected from the group consisting of acidic catalysts and basic catalysts.

5. The process of claim 4 where the acidic catalyst is selected from the group consisting of hydrochloric acid, sulfuric acid, trifluoroacetic acid, toluene sulfonic acid, acidic alumina, silica-alumina, sulfated zirconia, acidic ion exchange resins and mixtures thereof.

6. The process of claim 4 where the basic catalyst is selected from the group consisting of sodium hydroxide, lithium hydroxide, potassium hydroxide and hydrotalcite.

7. The process of claim 1 where the transition metal component comprises a compound selected from the group consisting of metal oxides, metal salts, organometallic compounds, and mixtures thereof.

8. The process of claim 7 where the transition metal compounds are selected from the group consisting of K₂Mn₄P₃O₁₆, MnPO₄. H₂O, Na₂Mn₂P₂O₉.H₂O, KMn₈O₁₆, Mn(II)trifluoroacetate, Mn(II) acetate, Mn(III)acetate, Co₂O₃, Co(II) Acetate, AgO, Ag(I)trifluoroacetate, Fe₂O₃, (FeMn)PO₄ and mixtures thereof.

9. The process of claim 1 where the transition metal component is deposited onto the inorganic oxide.

10. The process of claim 1 where the inorganic oxide is selected from the group consisting of silica, aluminas, aluminum phosphate, ceria, magnesium oxide, lanthanum oxide, molecular sieves and mixtures thereof.

11. The process of claim 1 where the oxidizing agent is intermittently added.

12. The process of claim 1 where the solvent is selected from the group consisting of trifluoroacetic acid, trifluoroacetic anhydride, pentafluoropropionic acid, acetic acid, super critical carbon dioxide, sulfuric acid, sulfur trioxide, trifluoromethanesulfonic acid, methanesulfonic acid and mixtures thereof.

13. The process of claim 1 where the process is a batch process.

14. The process of claim 1 where the process is a continuous process.

15. The process of claim 11 where the oxidizing agent is air.
